(19) United States
(12) Patent Application Publication
(10) Pub. No.: US 2014/0129865 A1
(43) Pub. Date: May 8, 2014

(54) SYSTEM CONTROLLER, POWER CONTROL METHOD, AND ELECTRONIC SYSTEM

(71) Applicant: FUJITSU LIMITED, Kawasaki-shi (JP)

(72) Inventor: Kazumi KOJIMA, Kawasaki (JP)

(73) Assignee: FUJITSU LIMITED, Kawasaki-shi (JP)

(21) Appl. No.: 14/154,256

(22) Filed: Jan. 14, 2014

Related U.S. Application Data
(63) Continuation of application No. PCT/JP2011/067553, filed on Jul. 29, 2011.

(51) Int. Cl. G06F 1/32

(52) U.S. Cl. CPC G06F 1/3206
USPC 713/324

(57) ABSTRACT

According to an aspect of an embodiment, a system controller included in a first electronic apparatus connected to a different electronic apparatus via a network, includes a monitoring unit and a power supply control unit. The monitoring unit mutually monitors a survival state with an operation system controller included in a second electronic apparatus. The power supply control unit, controls a power supply of a different system controller included in the first electronic apparatus to turn off when the monitoring unit starts monitoring a survival state of the operation system controller included in the second electronic apparatus.

### CROSS-REFERENCE TO RELATED APPLICATION

This application is a continuation of International Application No. PCT/JP2011/067553, filed on Jul. 29, 2011, the entire contents of which are incorporated herein by reference.

### FIELD

The embodiments discussed herein are related to a system controller, a power control method, and an electronic system.

### BACKGROUND

Heretofore, in a super computer including a plurality of information processors, most of components are formed in a duplicated system or in a redundant system in order that a system is not stopped and kept operating even, though a component is failed. For techniques of configuring such a super computer, there is an HPC (High Performance Computer, in the following, referred to as the HPC), for example.

For example, in the HPC, a service processor (in the following, referred to as the SP) that controls information processors is formed in a duplicated system. The information processor includes an active side SP and a standby side SP.

The active side SP controls the information processor as an operation system. On the other hand, the standby side SP is a standby system, and normally waits, which does not control the information processor. The standby side SP always monitors the survival state of the active side SP. In a ease where the active side is failed, the standby side SP switches itself to the active side, and then continues the operation of the information processor.

Moreover, in addition to the SP formed in a duplicated system, such a technique is known in which a device dedicated to monitoring is used to monitor the survival of information processors. See Japanese Laid-open Patent Publication No. 09-274575.

However, in the previously existing techniques described above, a problem arises in that a system controller, which is a standby system, wastes electric power.

More specifically, in the previously existing techniques, the stand-by side SP normally only waits, and does not control the system. Thus, the standby side SP only wastes electric power when no failure occurs in the system. However, when the availability of the system is assumed in a case where a component is failed, it is difficult, for the HPC to cancel the redundant configuration or the duplicated configuration of the SP. Thus, the power supply of the standby side SP is always on. Moreover, also in a case of using a device dedicated to monitoring, the power supply is similarly always on.

Furthermore, the HPC is demanded to have high performance, and a few hundreds devices are sometimes introduced in an overall data center. When a large number of devices are introduced as described above, power consumption becomes enormous, and it is desired to reduce power consumption per device.

### SUMMARY

According to an aspect, of an embodiment, a system controller included in a first electronic apparatus connected to a different electronic apparatus via a network, includes a monitoring unit and a power supply control unit. The monitoring unit mutually monitors a survival state with an operation system controller included in a second electronic apparatus. The power supply control unit controls a power supply of a different system controller included in the first electronic apparatus to turn off when the monitoring unit starts monitoring a survival state of the operation system controller included in the second electronic apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an exemplary system configuration of an HPC.

FIG. 2 is a block diagram of the configurations of information processors.

FIG. 3 is a functional block diagram of the configuration of an SP according to a first embodiment.

FIG. 4 is a diagram of exemplary items of information stored on a mutual monitoring table.

FIG. 5 is a diagram of an exemplary type determination notification sent from a monitoring target identifying unit.

FIG. 6 is a diagram of an exemplary mutual monitoring target notification sent from the monitoring target-identifying unit.

FIG. 7 is a diagram of an exemplary mutual monitoring table updated by a monitoring request, reply unit.

FIG. 8A is a diagram of a process operation of sending a type determination notification.

FIG. 8B is a diagram of a process operation of sending a mutual monitoring target notification.

FIG. 8C is a diagram of a process operation after starting mutual monitoring.

FIG. 9A is a diagram of a process operation in a case where the occurrence of an abnormality is detected.

FIG. 9B is a diagram of a process operation that mutual monitoring is requested after detecting the occurrence of an abnormality.

FIG. 9C is a diagram of an exemplary mutual monitoring table updated in the case where a reply to permit mutual monitoring is received.

FIG. 10 is a diagram of a process operation in a case where no mutual monitoring partner exists.

FIG. 11 is a diagram of a process operation when maintenance is set.

FIG. 12 is a flowchart of the process procedures of a process performed by the SP according to the first embodiment.

FIG. 13 is a flowchart of the process procedures of requesting mutual monitoring by the SP according to the first embodiment.

FIG. 14 is a flowchart of the process procedures performed by the SP according to the first embodiment when an abnormality occurs.

FIG. 15 is a flowchart of the process procedures of processing a notification performed by the SP according to the first embodiment when maintenance is set.

FIG. 16 is a flowchart of the process procedures of processing a reply to a mutual monitoring target notification by the SP according to the first embodiment.

FIG. 17 is a flowchart of the process procedures of processing a reply to a maintenance setting notification.

### DESCRIPTION OF EMBODIMENTS

Preferred embodiments of the present invention will be explained with reference to accompanying drawings. It is noted that the present invention is not limited to the embodiments. The embodiments can be appropriately combined within the scope in which the content of processes is not inconsistent.

### [a] First Embodiment

In a first embodiment, a service processor (in the following, referred to as the SP) will be taken and described as an example of a system controller. The SP is individually provided on information processors in an HPC (High Performance Computer, in the following, referred to as the HPC) including a plurality of information processors.

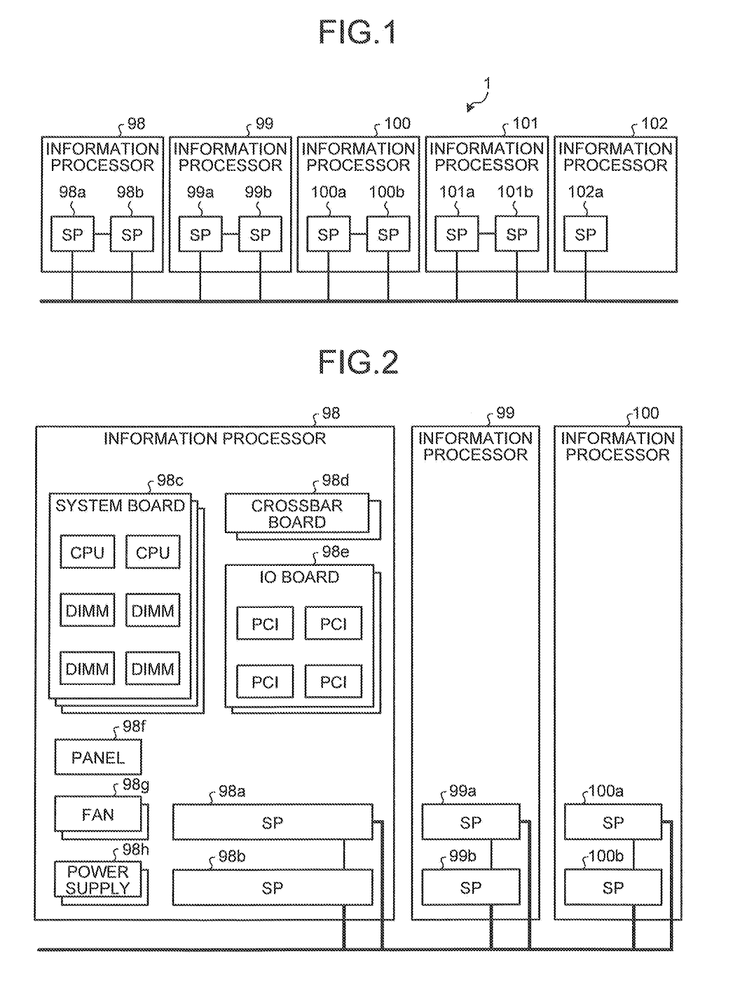

In the following, an exemplary system configuration of the HPC, the configuration of the SP according to the first embodiment, the process operations performed by the SP according to the first, embodiment, the process procedures of processes performed by the SP according to the first embodiment, and the effect of the first embodiment will be described in turn with reference to FIGS. 1 to 15.

### An Exemplary System Configuration of an HPC

FIG. 1 is a diagram of an exemplary system configuration of an HPC. As illustrated in FIG. 1, a HPC 1 includes information processors 98, 99, 100, 101, and 102. The information processors are connected to each other as the information processors can communicate with the other information processors via a network. It is noted that an exemplary system configuration of the HPC illustrated in FIG. 1 is merely an example, and the number of the information processors installed is not limited to the configuration in FIG. 1.

An SP 98a and an SP 98b included in the information processor 98 operate separately from the information processor 98, and control the information processor 98. Here, one of the SP 98a and the SP 98b operates as an operation system that controls the information processor 98, and the other is a standby system that waits and does not control the information processor 98.

In a case where the SP, which is an operation system, is failed, the SP, which is a standby system, switches itself to an operation system, and continues the operation of controlling the information processor 98. Namely, in the information processor 98, the SP is formed in a duplicated system with the SP 98a and the SP 98b. It is noted that in the description below, the description will be made as the SP 98a is an operation system and the SP 98b is a standby system unless otherwise specified.

Moreover, the configurations of the information processors 99, 100, and 101 are similar to the configuration of the information processor 98, and the detailed description is omitted on the configurations of the information processors 99, 100, and 101. It is noted that the description will be made as an SP 99a included in the information processor 99 is an operation system, an SP 99b is a standby system, an SP 100a included in the information processor 100 is an operation system, an SP 100b is a standby system, an SP 101a included in the information processor 101 is an operation system, and an SP 101b is a standby system.

The information processor 102 includes only an SP 102a, different from the information processor 98. Namely, in the information processor 102, the SP is not formed in a duplicated system. It is noted that the SP 102a normally operates as an operation system, and the description will be made below as the operation system SPs does not include the SP 102a.

Moreover, suppose that, the device types of the SP 98a, the SP 98b, the SP 99a, the SP 99b, the SP 100a, the SP 100b, the SP 101a, and the SP 101b illustrated in FIG. 1 are device type A, and the device type of the SP 102a is device type B. Namely, the SP 98a, the SP 98b, the SP 99a, the SP 99b, the SP 100a, the SP 100b, the SP 101a, and the SP 101b are the same type devices.

In the HPC 1 as decried above, the operation system SPs of the same type mutually monitor the survival state with the other operation system SPs selected according to a predetermined rule. Namely, the operation system SPs of the same type are formed, in a duplicated system with the other operation system SPs. The operation system SPs mutually monitor the survival state with the other operation system SPs, so that the standby system SPs does not monitor their operation system SPs. As a result, the power supplies of the standby system SPs are controlled to turn off.

### The Configuration of the Information Processor

Next, the configurations of the information processors 98, 99, 100, 101, and 102 will be described with reference to FIG. 2. FIG. 2 is a block diagram of the configurations of information processors. As illustrated in FIG. 2, the information processor 98 includes the SP 98a, the SP 98b, a system board 98c, a crossbar board 98d, an IO (Input Output) board 98e, a panel 98f, a fan 98g, and a power supply 98h.

It is noted that here, the configuration of the information processor will be described as the information processor 98 is taken as an example, and the configurations of the information processors 99, 100, and 101 are similar to the configuration of the information processor 98. Moreover, the configuration of the information processor 102 is similar to the configuration of the information processor 98 except that the SP is not formed in a duplicated system. Furthermore, the SP 98a and the SP 98b will be described later. Here, the system board 98c, the crossbar board 98d, the IO board 98e, the panel 98f, the fan 98g, and the power supply 98h will, be described.

The system board 98c includes pluralities of CPUs and DIMMs (Dual Inline Memory Modules), and executes various arithmetic operations. The information processor 98 includes a plurality of the system boards 98c, and sends and receives data between the system boards through the crossbar board 98d.

The IO (Input Output) board 98e includes PCI (Peripheral Component Interconnect) slots, and controls data input and output between the system board 98c and an external IO device connected via the network. Moreover, the IO board 98e may incorporate a hard disk.

The panel 98f provides an interface that accepts manipulations from a user to control the power supply 98h to turn on and off. Furthermore, the panel 98f outputs the internal information of the information processor 98 such as the operation time of the information processor 98 as the user can visually recognize the information.

The fan 98g cools electronic devices such as the system board 98c, the crossbar board 98d, and the IO board 98e included in the information processor 98.

The power supply 98h supplies electric power to the information processor. The power supply 98h may include a backup power supply.

### The Configuration of the SP according to the First Embodiment

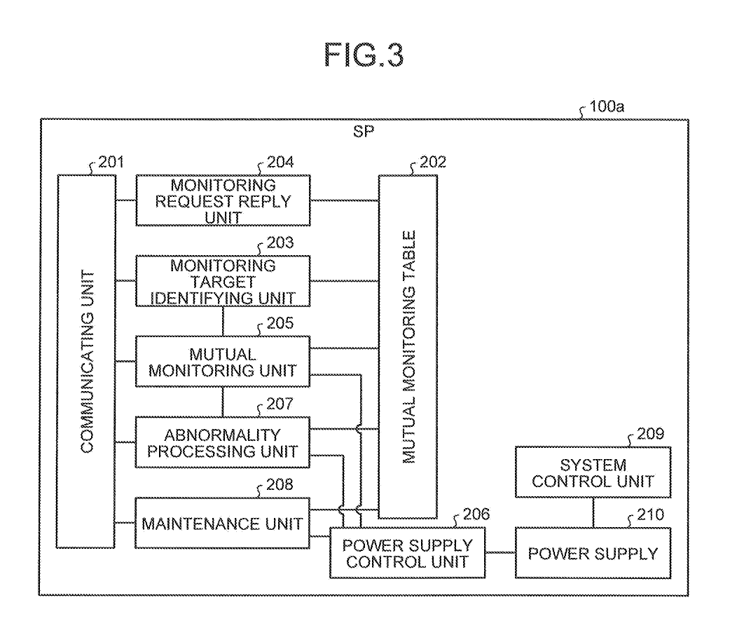

Next, the configurations of the SP 98a, the SP 98b, the SP 99a, the SP 99b, the SP 100a, the SP 100b, the SP 101a, and the SP 101b according to the first embodiment will be described with reference to FIG. 3. Here, the configuration of the SP 100a illustrated in FIG. 1 is taken and described as an example. FIG. 3 is a functional block diagram of the configuration of the SP according to the first embodiment. It is noted that the configurations of the SP 98a, the SP 98b, the SP 99a, the SP 99b, the SP 100b, the SP 101a, and the SP 101b are similar to the configuration of the SP 98a.

As illustrated in FIG. 3, the SP 100a includes a communicating unit 201, a mutual monitoring table 202, a monitoring target identifying unit 203, a monitoring request reply unit 204, a mutual monitoring unit 205, a power supply control unit 206, an abnormality processing unit 207, a maintenance unit 208, a system control unit 209, and a power supply 210. Here, the power supply control unit 206 is connected to a power supply included in the SP 100b in the information processor also including the SP 100a through a bus. Moreover, the power supply 210 is connected to the power supply control unit included in the SP 100b in the information processor also including the SP 100a through the bus.

The communicating unit 201 controls sending and receiving information with the SP connected via the network. For example, the communicating unit 201 sends a packet generated at the monitoring target identifying unit 203, described later, to the SP 99a. Furthermore, the communicating unit 201 outputs a packet received from the SP 99a to the monitoring target identifying unit 203, described later.

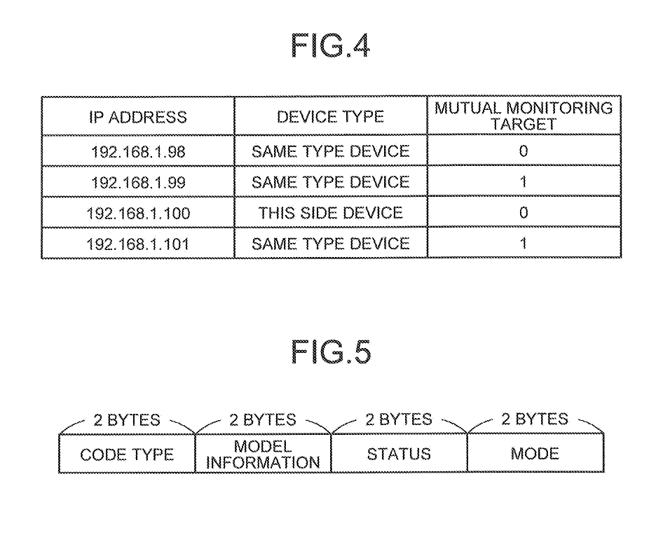

The mutual monitoring table 202 stores information about the SP, for example, with which the SP 100a is in mutual monitoring. Exemplary items of information stored as the mutual monitoring table 202 will be described with reference to FIG. 4. FIG. 4 is a diagram of exemplary items of information stored on the mutual monitoring table. As illustrated in FIG. 4, the mutual monitoring table 202 stores “an IP address”, “a device type”, and “a mutual monitoring target” in association with, each other.

Here, “the IP address” stored as the mutual monitoring table 202 indicates IP (Internet Protocol) addresses allocated to the SPs. For example, “192.168.1.98”, “192,168.1.99”, and “192.168.1.100”, for example, are stored on “the IP address”.

Moreover, “the device type” stored as the mutual monitoring table 202 expresses whether the SP linked to the IP address is the same type device as this side SP. “The same type device” referred here means that the device type is the same type. For example, on “the device type”, “the same type device” indicating the same type device and “this side device” indicating this side SP, for example, are stored.

Furthermore, “the mutual monitoring target” stared as the mutual monitoring table 202 expresses whether the SP linked to the IP address is a mutual monitoring target. “The mutual monitoring target” referred here means “the SP to be a target of which survival state is in mutual monitoring with each other”. For example, on “the mutual monitoring target”, “1” is stored in a case where the SP linked to the IP address is a mutual monitoring target, whereas “0” is stored in a case where the SP linked to the IP address is not a mutual monitoring target.

In the example illustrated in FIG. 4, the mutual monitoring table 202 expresses that the SP whose IP address is “192.168.1.98” is the same type device and that the SP is not a mutual monitoring target. In addition, the mutual monitoring table 202 expresses that the SP of which IP address is “192.168.1.99” is the same type device and that the SP is a mutual monitoring target.

Again referring to FIG. 3, the monitoring target identifying unit 203 identifies the SP to be a target of which survival state is in mutual monitoring with each other from the operation system SPs connected to the SP 100a via the network.

First, the monitoring target identifying unit 203 identifies the same type device that is possibly a candidate for the SP to be a target of which survival state is in mutual monitoring with each other. For example, the monitoring target identifying unit 203 communicates with ail the SPs included in the HPC 1 in broadcast, arid detects the same type device that is possibly a mutual monitoring target. Here, the monitoring target identifying unit 203 sends a packet according to the SNMP (Simple Network Management Protocol) using the IPMI (Intelligent Platform Management Interface), for example. It is noted that the packet to detect the same type device that is possibly a mutual monitoring target, which is sent from the monitoring target identifying unit 203, will be described as “a type determination notification”.

The type determination notification sent from the monitoring target identifying unit 203 will be described with reference to FIG. 5. FIG. 5 is a diagram of an exemplary type determination notification sent from the monitoring target identifying unit. As illustrated in FIG. 5, a type determination notification sent from the monitoring target identifying unit 203 includes the fields of “a code type” in two bytes, “model information” in two bytes, “status” in two bytes, and “a mode” in two bytes.

“The code type” is information expressing whether the packet is a packet, that makes an inquiry about the same type device or a response packet to an inquiry. For example, “the code type” stores “0001” expressing a packet, that makes an inquiry about the same type device and “0002” expressing a response packet.

Moreover, “the model information” is information expressing a device type. For example, “the model information” stores “0001” expressing that the device type is A and “0002” expressing that the device type is B, for example.

Furthermore, “the status” is information expressing the state of the SP. For example, “the status” stores “0001” expressing that the SP is not a redundant system, “0002” expressing that the SP is formed in a duplicated system, and “0003” expressing that the SP is in an abnormality state, for example.

In addition, “the mode” is information expressing the operation state of the SP. For example, “the mode” stores “0000” expressing that, the SP is normally operating, “0001” expressing that the SP is idle, and “0002” expressing that the SP is in a maintenance state, for example.

For example, the monitoring target identifying unit 203 sends a type determination notification that stores “0001” on “the code type” illustrated in FIG. 5 to all the SPs on the network.

Subsequently, the monitoring target identifying unit 203 receives replies to the type determination notification from the same type devices, reads “model information”, and determines whether the same type device exists. Here, in a case where the monitoring target identifying unit 203 determines that the same type device exists, the monitoring target identifying unit 203 extracts IP addresses included in the replies to the type determination notification from all the same type devices. The monitoring target identifying unit 203 then sorts the list of the extracted same type devices in order of the IP addresses.

The case will be described where the monitoring target identifying unit 203 of the SP 100a receives the replies to the type determination notification arid sorts the list of the same type devices in order of the IP addresses in the example illustrated in FIG. 1. Here, suppose that the IP addresses are allocated to the SPs as below. Namely, IP address “192.168.1.98” is allocated to the SP 98a, and IP address “192.168.1.99” is allocated to the SP 99a. Moreover, IP address “192.168.1.100” is allocated to the SP 100a, and IP address “192.168.1.101” is allocated to the SP 101a. It is noted that the allocation of the IP addresses to the SPs is not limited to the example above, and can be freely modified.

For example, the monitoring target identifying unit 203 receives the replies to the type determination notification from the SP 98a, the SP 99a, and the SP 101a, which are the same type devices. The monitoring target identifying unit 203 then sorts the list of the same type devices, from which the monitoring target identifying unit 203 receives the replies to the type determination notification, in order of the IP addresses. For an example, the monitoring target identifying unit 203 sorts the IP addresses in the order of “192.168.1.98”, “192,168,1.99”, and “192.168.1.101”.

Subsequently, the monitoring target identifying unit 203 selects a candidate for a mutual monitoring target according to a predetermined rule. For example, for a predetermined rule, the monitoring target identifying unit 203 selects two SPs preceding and subsequent to the SP 100a for candidates for a mutual monitoring target from the sorted IP addresses.

For example, the monitoring target identifying unit 203 selects the SP 99a of which IP address is “192.168.1.99” and the SP 101a of which IP address is “192.168.1.101” for candidates for a mutual monitoring target. It is noted that in the embodiment, the description will be made as two SPs preceding and subsequent to this side SP are mutual monitoring targets. However, mutual monitoring targets are not limited to this example, and the number of the mutual monitoring targets may be one or three or more, for example.

The monitoring target identifying unit 203 generates a packet to request mutual monitoring for the selected candidates for a mutual monitoring target, and sends the generated packet to the destinations of the mutual monitoring request. It is noted that in the following, the packet to request mutual monitoring is appropriately described as “the mutual monitoring target notification”.

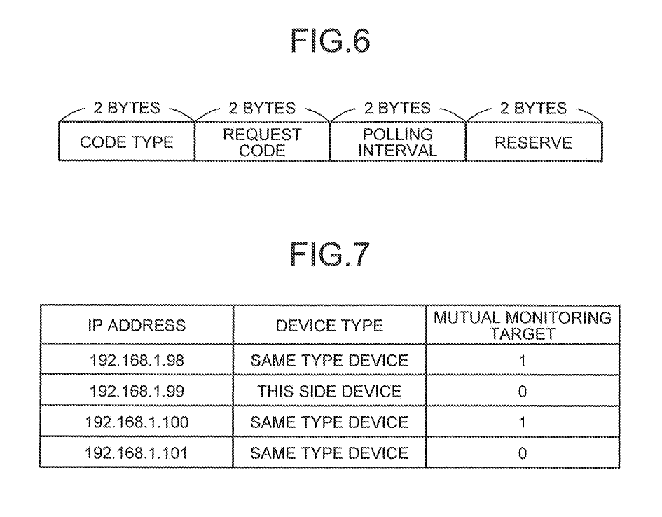

The mutual monitoring target notification sent from the monitoring target identifying unit 203 will be described with reference to FIG. 6. FIG. 6 is a diagram of an exemplary mutual monitoring target notification sent from the monitoring target identifying unit 203. As illustrated in FIG. 6, the mutual monitoring target notification sent from the monitoring target identifying unit 203 includes the fields of “a code type” in two bytes, “a request code” in two bytes, “a polling interval” in two bytes, and “a reserve” in two bytes.

“The code type” is information expressing whether the packet is a packet to request mutual monitoring or a response packet to the mutual monitoring request. For example, “the code type” stores “0001” expressing that the packet is a packet, to request mutual monitoring and “0002” expressing that the packet is a response packet to the mutual monitoring request.

“The request code” is information expressing whether the mutual monitoring target notification is a packet to request mutual monitoring or a packet to notify the maintenance mode. For example, “the request code” stores “0001” expressing that the mutual monitoring target notification is a packet to request mutual monitoring and “0002” expressing that the mutual monitoring target notification is a packet to notify the maintenance mode.

“The polling interval” is information expressing intervals for mutual monitoring. For example, in a case where mutual monitoring is performed at five-second intervals, “the polling interval” stores “0005”. “The reserve” is a free space, and used for matching data in eight bytes.

For example, the monitoring target identifying unit 203 sends a mutual monitoring target notification in which “0001” is stored on “the request code” illustrated in FIG. 5 and “0005” is stored on “the polling interval” to candidates for a mutual monitoring target.

Again referring to FIG, 3, the monitoring target identifying unit 203 receives replies to the sent mutual monitoring target notification from the selected destinations of the mutual monitoring request, and determines whether the mutual monitoring target notification is permitted based on the received replies.

For example, the monitoring target identifying unit 203 determines whether a message to permit mutual monitoring is included in the reply to the mutual monitoring target notification received from the destination of the mutual monitoring request. Here, in a case where a message to permit mutual monitoring is included in the reply, the monitoring target identifying unit 203 determines that the monitoring target identifying unit 203 receives the reply to permit mutual monitoring. The monitoring target identifying unit 203 then updates the mutual monitoring table 202, and identifies the operation system SP that permits mutual monitoring as a mutual monitoring target.

For an example, in a case where the monitoring target, identifying unit 203 receives a reply to permit mutual monitoring from the SP 99a and the SP 101a, the monitoring target identifying unit 203 updates the mutual monitoring table 202, and identifies the, SP 99a and the SP 101a as mutual monitoring targets as illustrated in FIG. 4. Namely, “1” is stored on “the mutual monitoring target” linked to IP address “192.168.1.99” of the SP 99a, and “1” is stored on “the mutual monitoring target” linked to IP address “192.168.1.101” of the SP 101a.

Moreover, in a case where a message to permit mutual monitoring is not included in the reply, the monitoring target identifying unit 203 determines that the monitoring target identifying unit 203 receives a reply not to permit mutual monitoring. As a result, the monitoring target identifying unit 203 selects a new candidate for a mutual monitoring target, and sends a mutual monitoring target notification to the selected candidate for a mutual monitoring target.

Again referring to FIG. 3, the monitoring request-reply unit 204 receives a request to mutually monitor the survival state from an operation system SP connected to the SP 100a via the network, and determines whether to permit mutually monitoring the survival state.

For example, in a case where the monitoring request reply unit 204 receives a type determination notification from a different operation system SP, the monitoring request reply unit 204 determines whether the SP 100a is the same type device as the source SP of the type determination notification. In a case where the monitoring request reply unit 204 determines that the SP 100a is the same type device as the source SP of the type determination notification, the monitoring request reply unit 204 sends a response packet to the type determination notification. Here, the monitoring request reply unit 204 generates a packet including a device type, information expressing whether the SP is formed in a duplicated system, and information expressing whether to be an appropriate device as a mutual monitoring target, and sends the generated packet as a reply to the type determination notification to the source SP of the type determination notification.

Moreover, in a case where the monitoring request reply unit 204 receives a mutual monitoring target notification from an operation system SP connected to the SP 100a via the network, the monitoring request reply unit 204 determines whether to permit, mutually monitoring the survival state for the source of the received mutual monitoring target notification.

For example, the monitoring request reply unit 204 updates the mutual monitoring table 202, and determines whether to be an appropriate device as a mutual monitoring target. FIG. 7 is a diagram of an exemplary mutual monitoring table updated at the monitoring request reply unit. In FIG. 7, the case is taken as an example where the monitoring request reply unit 204 of the SP 99a of which IP address is “192.168.1.99” receives a mutual monitoring target notification from the SP 100a of which IP address is “192.168.1.100”, and updates the mutual monitoring table 202. As illustrated in FIG. 7, the SP 99a stores “1” on “the mutual monitoring target” linked to IP address “192.168.1.100”.

In a case where the monitoring request reply unit 204 then determines to permit mutually monitoring the survival state, the monitoring request reply unit 204 generates a packet including a message to permit mutual monitoring, and sends the generated packet as a reply to the mutual monitoring target notification to the source SP of the mutual monitoring target notification.

On the other hand, in a case where the monitoring request reply unit 204 determines that mutually monitoring the survival state is not permitted, the monitoring request reply unit 204 generates a packet including a message not to permit mutual monitoring, and sends the generated packet as a reply to the mutual monitoring target notification to the source SP of the mutual monitoring target notification.

Again referring to FIG. 3, the mutual monitoring unit 205 mutually monitors the survival state with an operation system SP in an information processor connected to the information processor including the SP 100a via the network with reference to the mutual monitoring table 202.

For example, in a case where the mutual monitoring unit 205 is notified from the monitoring target identifying unit 203 that the mutual monitoring target, is identified, the mutual monitoring unit 205 mutually monitors the survival state with the operation system SP, which is the identified mutual monitoring partner. After starting mutual monitoring, the mutual monitoring unit 205 identifies the mutual monitoring target, with reference to the mutual monitoring table 202. Namely, in a case where the mutual monitoring table 202 is updated, the mutual monitoring unit 205 performs mutual monitoring with the mutual monitoring target after updated.

Moreover, the mutual monitoring unit 205 notifies the power supply control unit 206 that the mutual monitoring unit 205 starts mutual monitoring. As a result, the power supply control unit 206 controls the power supply included in the SP 100b to turn off, which is a standby system, to the SP 100a.

The mutual monitoring unit 205 monitors the survival state of the mutual monitoring target SP by determining whether it is enabled to communicate with the mutual monitoring target SP through the communicating unit 201. In a case where the mutual monitoring unit 205 then determines that it is enabled to communicate with the mutual monitoring target SP through the communicating unit 201, the mutual monitoring unit 205 determines that, the mutual monitoring target SP normally operates. On the other hand, in a case where the mutual monitoring unit 205 determines that it is not enabled to communicate with the mutual monitoring target SP through the communicating unit 201, the mutual monitoring unit 205 determines that the mutual monitoring target SP abnormally operates.

In a case where the mutual monitoring unit 205 then determines that the mutual monitoring target SP abnormally operates, the mutual, monitoring unit 205 notifies the abnormality processing unit 207 of the SP 100a that it becomes unable to communicate with the mutual monitoring target. As a result, the abnormality processing unit 207 performs an abnormality process, described later.

Here, in a case, where the abnormality processing unit 207 updates the mutual monitoring target, the mutual monitoring unit 205 performs mutual monitoring with the updated mutual monitoring target.

The power supply control unit 206 receives various notifications from the mutual monitoring unit 205, the abnormality processing unit 207, or the maintenance unit 208, and controls the power supply 210 to turn on and off or a power supply to turn on and off, which is included in the SP 100b included in the information processor also including the SP 100a.

For example, in a case where the power supply control unit 206 is notified from the mutual monitoring unit 205 that, mutual monitoring is started with the operation system SP, which is a mutual monitoring target, the power supply control unit 206 controls the power supply included in the SP 100b to turn off, which is a standby system to the SP 100a.

Moreover, in a case where the abnormality processing unit 207, described later, determines that it is difficult to identify the operation system SP, which is a monitoring target, the power supply control unit 206 controls the power supply included in the SP 100b to turn on, which is a standby system to the SP 100a.

Furthermore, in a case where the power supply control unit 206 is notified from, the abnormality processing unit 207 that the power supply 210 included in the SP 100a is controlled to turn on, the power supply control unit 206 controls the power supply 210 to turn on. It is noted that the control is performed in a case where the SP 100a is a standby system to the SP 100b and an abnormality occurs in the SP 100b, which is an operation system.

In addition, in a case where the power supply control unit 206 is notified from the maintenance unit 208, described later, that a maintenance setting is received, the power supply control unit 206 controls the power supply included in the SP 100b to turn on, which is a standby system to the SP 100a.

Moreover, in a case where the power supply control unit 206 is notified from the maintenance unit 208 that the power supply included in the SP 100b, which is a standby system to the SP 100a, is controlled to turn on, the power supply control unit 206 controls the power supply included in the SP 100b to turn on, which is a standby system to the SP 100a. It is noted that the control is performed in a case where the maintenance unit 208 receives a maintenance setting notification from the operation system SP, which is a mutual monitoring target, and then determines that it is difficult to identify the operation system SP, which is a mutual monitoring target. It is noted that the maintenance setting notification will be described later.

Again referring to FIG. 3, in a case where the abnormality processing unit 207 is notified from the mutual monitoring unit 205 that an abnormality occurs in the mutual monitoring target, the abnormality processing unit 207 performs the abnormality process. For example, the abnormality processing unit 207 controls the power supply of the SP 99b to turn on, which is a standby system to the SP 99a, which is a mutual monitoring target.

For an example, the abnormality processing unit 207 notifies an abnormality processing unit included in the SP 99b that an abnormality occurs in the SP 99a through the communicating unit 201. As a result, the abnormality processing unit included in the SP 99b notifies a power supply control unit to control a power supply included in the SP 99b to turn on.

Moreover, the abnormality processing unit 207 identifies a new mutual monitoring target according to a predetermined rule. It is noted that a predetermined rule referred here is the same as a predetermined rule used for describing the monitoring target identifying unit 203. For example, the abnormality processing unit 207 updates the mutual monitoring table 202 in such a way that the SP in which an abnormality occurs is removed from the mutual monitoring target, and identifies a new candidate for a mutual monitoring target from the updated mutual monitoring table 202.

The operation of the abnormality processing unit 207 will be described as the case is taken as an example where an abnormality occurs in the SP 99a of which IP address is “192.168.1.99” in the mutual monitoring table 202 illustrated in FIG. 4. The abnormality processing unit 207 stores “0” on “the mutual monitoring target” corresponding to IP address “192.168.1.99”, and identifies the SP 98a of which IP address is “192.168.1.98” as a candidate for a mutual monitoring target.

The abnormality processing unit 207 then generates a mutual monitoring target notification to request mutual monitoring to the identified candidate for a mutual monitoring target, and sends the generated mutual monitoring target notification to the destination of the mutual monitoring request. It is noted that the mutual monitoring target notification sent from the abnormality processing unit 207 is similar to the mutual monitoring target notification sent from the monitoring target identifying unit 203.

Moreover, the abnormality processing unit 207 receives a reply to the sent mutual monitoring target notification from the operation system SP, which is a candidate for a mutual monitoring target, and determines whether the mutual monitoring target, notification is permitted based on the received reply.

For example, the abnormality processing unit 207 determines whether a message to permit mutual monitoring is included in the reply to the mutual monitoring target notification received from the operation system. SP. Here, in a case where a message to permit mutual monitoring is included in the reply, the abnormality processing unit 207 determines that the abnormality processing unit 207 receives a reply to permit mutual monitoring, updates the mutual monitoring table 202, and identifies the candidate for a mutual monitoring target as a new mutual monitoring target.

For example, in a case where the abnormality processing unit 207 receives a reply to permit mutual monitoring from the SP 98a, the abnormality processing unit 207 stores “1” on “the mutual monitoring target” corresponding to IP address “192.168.1.98” of the SP 98a.

Furthermore, in a case where a message to permit mutual monitoring is not included in the reply, the abnormality processing unit 207 determines that the abnormality processing unit 207 receives a reply not to permit mutual monitoring. As a result, the abnormality processing unit 207 identifies a new candidate for a mutual monitoring target, and sends a mutual monitoring target notification to the identified candidate for a mutual monitoring target.

It is noted that, in a case where the abnormality processing unit 207 does not receive any reply to permit-mutual monitoring from the SPs, the abnormality processing unit 207 notifies the power supply control unit 206 to control the power supply included in the SP 100b to turn on, which is a standby system to the SP 100a.

In a case where the user sets the maintenance mode, the maintenance unit 208 notifies the power supply control unit 206 that the maintenance mode is set. As a result, the power supply control unit 206 controls the power supply included in the SP 100b to turn on, which is a standby system to the SP 100a. It is noted that the maintenance mode means that the SP is assigned to maintain itself.

In addition, in a case where the SP 100a is set in the maintenance mode, the maintenance unit 208 notifies a maintenance unit, included in the operation, system SP, which mutually monitors the survival state, that the SP 100a is set in the maintenance mode, and generates and sends a packet to request that the SP 100a is removed from the mutual monitoring target. In this case, the maintenance unit 208 stores “0002” expressing the notification of the maintenance mode on “the request code” of the mutual monitoring target notification, and sends the mutual monitoring target notification to the mutual monitoring target. It is noted that in the following, the packet to notify that this side SP is set in the maintenance mode is appropriately described as “the maintenance setting notification”.

Moreover, in a case where the maintenance unit 208 receives a maintenance setting notification from an SP included in a different information processor via the network, the maintenance unit 208 determines whether a candidate for a mutual monitoring target exists. In a case where the maintenance unit 208 then determines that a candidate for a mutual monitoring target exists, the maintenance unit 208 sends a mutual monitoring target notification to a candidate for a mutual monitoring target.

The maintenance unit 208 receives a reply to the sent mutual monitoring target notification from the operation system SP, which is a candidate for a mutual monitoring target, and determines whether the mutual monitoring target notification is permitted based on the received reply.

For example, the maintenance unit 208 determines whether a message to permit mutual monitoring is included in the reply to the mutual monitoring target notification, received from the operation system SP. Here, in a case where a message to permit mutual monitoring is included in the reply, the maintenance unit 208 determines that the maintenance unit 208 receives a reply to permit, mutual monitoring, updates the mutual monitoring table 202, and identifies the candidate for a mutual monitoring target as a new mutual monitoring target.

On the other hand, in a case where a message to permit mutual, monitoring is not included in the reply, the maintenance unit 208 determines that the maintenance unit 208 receives a reply not to permit mutual monitoring. As a result, the maintenance unit 208 identifies a new candidate for a mutual monitoring target, and sends a mutual monitoring target notification to the identified candidate for a mutual monitoring target.

It is noted that, in a case where the maintenance unit 208 does not receive any reply to permit mutual monitoring from the SPs, the maintenance unit 208 notifies the power supply control unit 206 to control the power supply included in the SP 100b to turn on, which is a standby system to the SP 100a.

Moreover, the maintenance unit 208 sets the fact that the SP 100a is set in the maintenance mode on a non-volatile region included in the SP 100a. The value set on the non-volatile region is not deleted and is held, even though the SP 100a is rebooted.

The system control unit 209 acquires the monitoring history and the operation history of the operation status in the information processor 100, and controls the, information processor 100, The power supply 210 is the power supply of the SP 100a, and controlled to turn on or off by the power supply control unit 206 and by the power supply control unit included in the SP 100b.

It is noted that the monitoring target identifying unit 203, the monitoring request reply unit 204, the mutual monitoring unit 205, the power supply control unit 206, the abnormality processing unit 207, the maintenance unit 208, and the system control unit 209 can be formed using an integrated circuit such as an ASIC (Application Specific Integrated Circuit), for example.

Moreover, electric power is constantly supplied to the communicating unit, the abnormality processing unit, and the power supply control unit included in the standby system SP of which power supply is controlled to turn off. Therefore, in a case where an SP included in a different information processor notifies that an abnormality occurs in an operation system SP in the information processor also including this side SP, a standby system SP of which power supply is turned off can control its own power supply to turn on.

### The Process Operation by the SP According to the First Embodiment

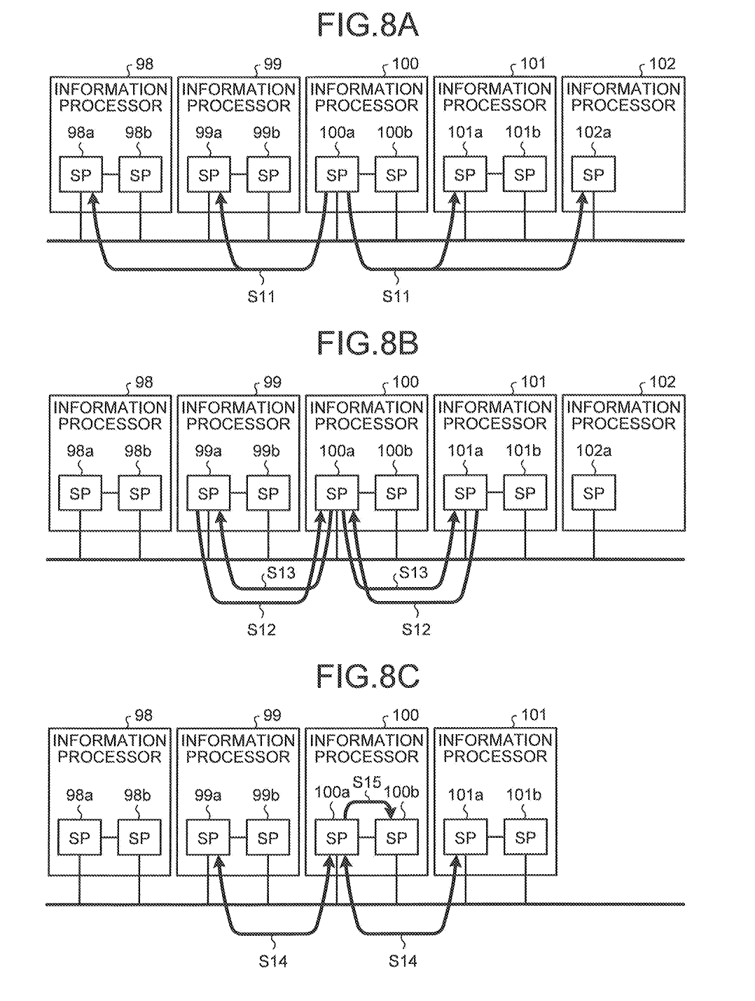

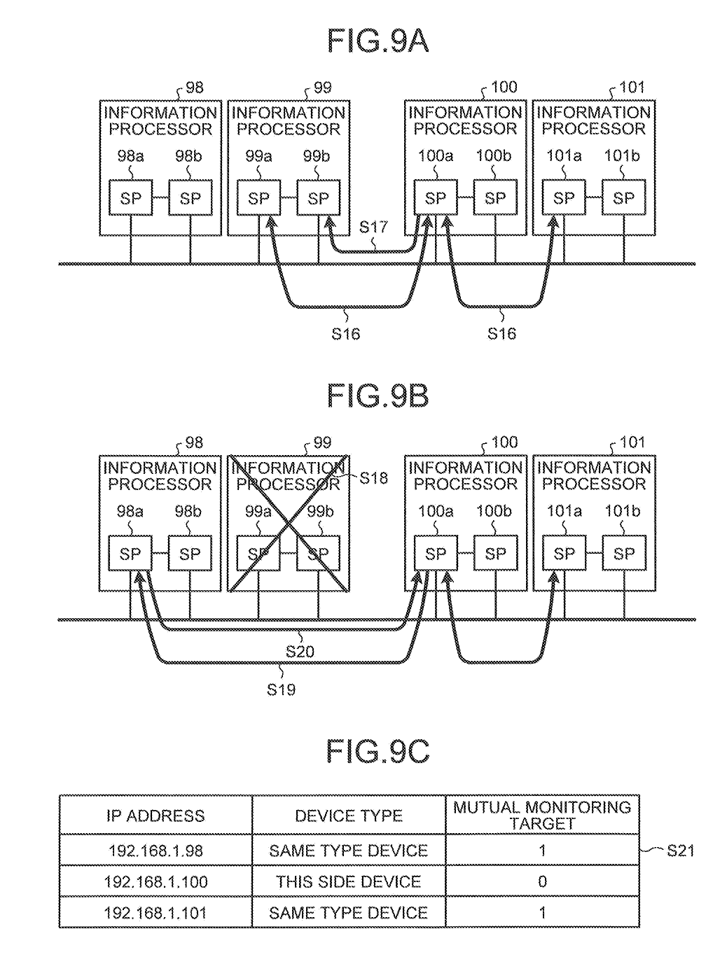

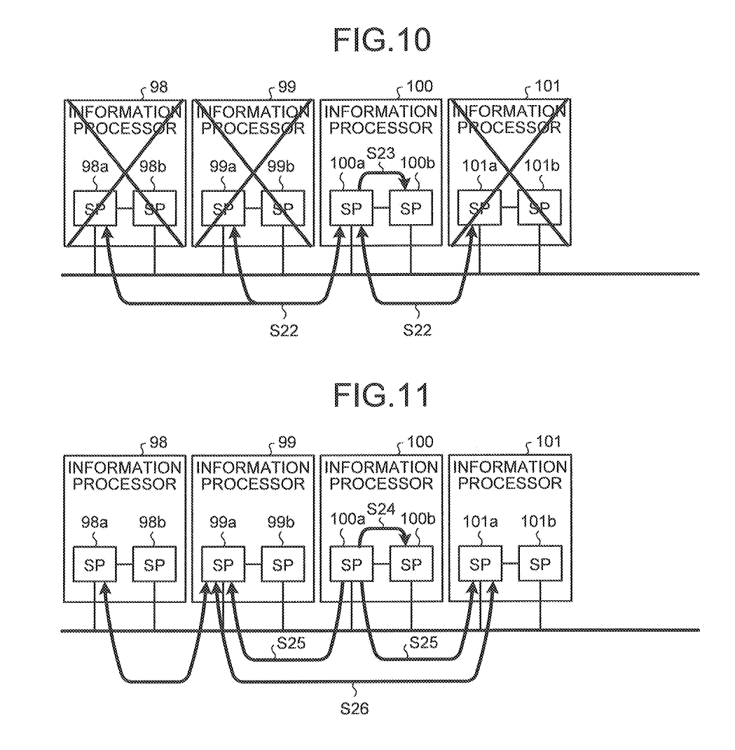

Next, the process operations of the SPs 98a, 99a, 100a, and 101a according to the first embodiment will be described. Here, the process operation of requesting mutual monitoring will be described with reference to FIGS. 8A to 8C. The process operation when an abnormality occurs will be described with reference to FIGS. 9A to 9C. The process operation in a case where no mutual monitoring partner exists will be described with reference to FIG. 10. The process operation when maintenance is set will be described with reference to FIG. 11.

### The Process Operation of Requesting Mutual Monitoring

FIG. 8A is a diagram of a process operation of sending a type determination notification, FIG. 8B is a diagram of a process operation of sending a mutual monitoring target notification, and FIG. 8C is a diagram of a process operation after starting mutual monitoring.

In FIG. 8A, the information processor 100 is just started, and both of the power supplies of the SP 100a and the SP 100b are on. The SP 100a, which is an operation system, then sends a type determination notification to the SPs included in the information processors 98, 99, 101, and 102 (Step S11).

In FIG. 8B, the SP 100a receives replies to the type determination notification (Step S12), and sends a mutual monitoring target notification to the SP 99a and the SP 101a based on the received replies (Step S13). In a case where the SP 100a then receives replies to permit, mutual monitoring from the SP 99a and the SP 101a, the SP 100a starts mutual monitoring with the SP 99a and the SP 101a.

In FIG. 8C, the SP 100a starts mutual monitoring with the SP 99a and the SP 101a (Step S14), and controls the power supply of the SP 100b to turn off (Step S15). As described above, the SP 100a controls the power supply of the SP 100b to turn off, which is a standby system, so that the SP 100a can reduce the power consumption of the standby system.

### The Process Operation when an Abnormality Occurs

FIG. 9A is a diagram of a process operation in a case where the occurrence of an abnormality is detected, FIG. 9B is a diagram of a process operation that mutual monitoring is requested after detecting the occurrence of an abnormality, and FIG. 9C is a diagram of an exemplary mutual monitoring table updated in a case where a reply to permit mutual monitoring is received.

In FIG. 9A, the SP 100a is in mutual monitoring with the SP 99a and the SP 101a (Step S16), and detects that an abnormality occurs in the SP 99a. The SP 100a then controls the power supply of the SP 99b to turn on, which is a standby system to the SP 99a (Step S17).

Subsequently, in FIG. 9B, the SP 100a removes the SP 99a from the mutual monitoring target (Step S18), and sends a mutual monitoring target notification to the SP 98a (Step S19). In a case where the SP 100a then receives a reply to permit, mutual monitoring from the SP 98a (Step S20), the SP 100a updates the mutual monitoring table 202 as illustrated in FIG. 9C. Namely, the SP 100a stores “1” on “the mutual monitoring target” linked to IP address “192.168.1.98” (Step S21).

### The Process Operation in a case where No Mutual Monitoring Partner Exists

FIG. 10 is a diagram of a process operation in a case where no mutual monitoring partner exists. In FIG. 10, the case is illustrated where the SP 100a sends a mutual monitoring target notification (Step S22), but receives no reply to permit mutual monitoring from any of the SP 98a, the SP 99a, and the SP 101a. In this case, the SP 100a controls the power supply of the SP 100b to turn on (Step S23), and the SP 100a is formed in a duplicated system with the SP 100b, in mutual monitoring with no other operation system SPs.

### The Process Operation when Maintenance is Set

FIG. 11 is a diagram of a process operation when maintenance is set. In FIG. 11, the SP 98a and the SP 99a are in mutual monitoring with each other, the SP 99a and the SP 100a are in mutual monitoring with each other, and the SP 100a and the SP 101a are in mutual monitoring with each other.

In this state, in a case where the SP 100a is set in the maintenance state, the SP 100a controls the power supply of the SP 100b to turn on (Step S24), and sends a maintenance setting notification to the SP 99a and the SP 101a, which are mutual monitoring targets (Step S25). In a case where the SP 100a then receives replies to the maintenance setting notification from the SP 99a and the SP 101a, the SP 100a is removed from the mutual monitoring target by the SP 99a and the SP 101a. As a result, the SP 99a and the SP 101a start mutual monitoring (Step S26).

### The Process Procedures of the SP according to the First Embodiment

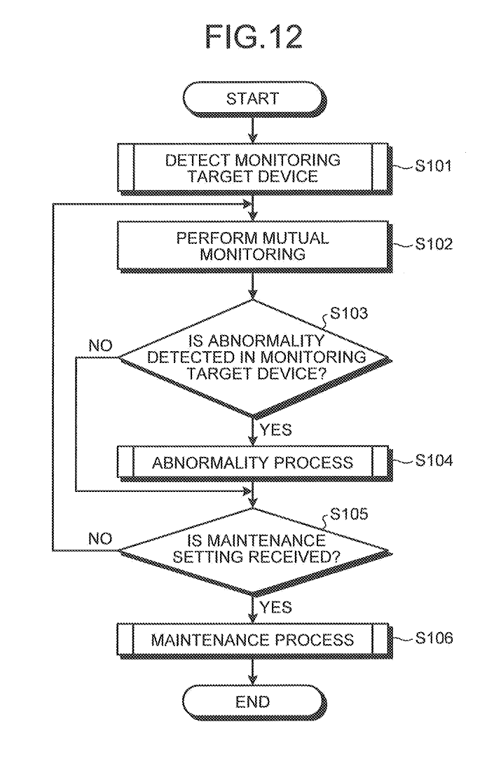

Next, the process procedures of processes performed by the SPs 98a, 99a, 100a, and 101a according to the first embodiment will be described with reference to FIGS. 12 to 17.

### The Flow of the Overall Processes

First, processes performed by the SPs 98a, 99a, 100a, and 101a according to the first embodiment will be described with reference to FIG. 12. FIG. 12 is a flowchart of the process procedures of a process performed by the SP according to the first embodiment. The SPs 98a, 99a, 100a, and 101a perform processes when they are started, for example. Moreover, in this case, suppose that the power supplies of the SPs, which are standby systems to the SPs 98a, 99a, 100a, and 101a, are turned on. It is noted that here, the flow of the, overall processes will be described as the SP 100a is taken as an example, and the similar processes are performed at the other SPs.

As illustrated in FIG. 12, the SP 100a detects a device for mutual monitoring (Step S101). The SP 100a then performs mutual monitoring with the detected device (Step S102), and determines whether an abnormality occurs in the device in mutual monitoring with each other (Step S103),

Here, in a case where the SP 100a determines that an abnormality occurs in the device in mutual monitoring with each other (Yes in Step S103), the SP 100a performs the abnormality process (Step S104). The SP 100a performs the abnormality process, and then goes to Step S105. On the other hand, in a case where the SP 100a determines that no abnormality occurs in the device in mutual monitoring with each other (No in Step S103), the SP 100a goes to Step S105.

The SP 100a goes to Step S105, and determines whether the SP 100a receives a maintenance setting (Step S105). Here, in a case where the SP 100a determines that the SP 100a does not receive any maintenance setting (No in Step S105), the SP 100a goes to Step S102, and performs mutual monitoring.

On the other hand, in a case where the SP 100a determines that the SP 100a receives a maintenance setting (Yes in Step S105), the SP 100a performs the maintenance process (Step S106), and ends the process.

### The Process of Requesting Mutual Monitoring

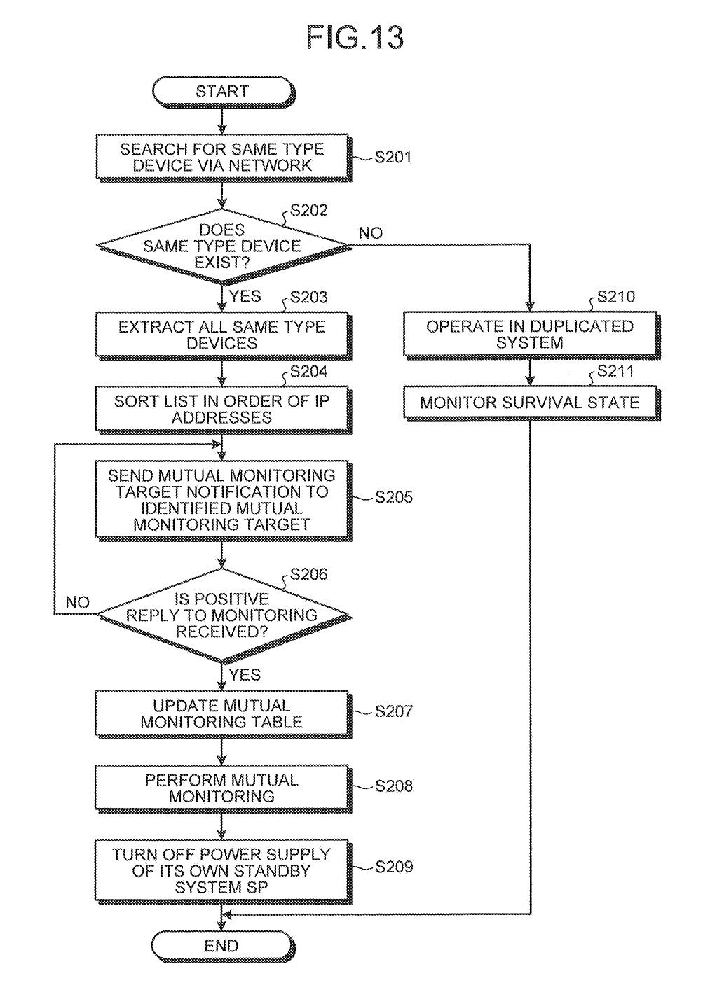

Next, the process of requesting mutual monitoring by the SPs 98a, 99a, 100a, and 101a according to the first embodiment will be described with reference to FIG. 13. FIG. 13 is a flowchart of the process procedures of requesting mutual monitoring by the SP according to the first embodiment. It is noted that the process corresponds to the process in Step S101 illustrated in FIG. 12. Moreover, here, the process of requesting mutual monitoring will be described as the SP 100a is taken as an example, and the similar process is performed at the other SPs.

As illustrated in FIG. 13, the SP 100a searches for the same type device via the network (Step S201). The SP 100a then determines whether the same type device exists (Step S202). Here, in a case where the SP 100a determines that the same type device exists (Yes in Step S202), the SP 100a extracts all the same type devices (Step S203).

The SP 100a then sorts the list of the extracted same type devices in the order of the IP addresses (Step S204). Subsequently, the SP 100a identifies a mutual monitoring target according to a predetermined rule, and sends a mutual monitoring target notification to the identified mutual monitoring target (Step S205). After that, the SP 100a determines whether the SP 100a receives a reply to permit mutual monitoring (Step S206).

Here, in a case where the SP 100a determines that the SP 100a receives a reply to permit mutual monitoring (Yes in Step S206), the SP 100a updates the mutual monitoring table 202 (Step S207), and performs mutual monitoring (Step S208). The SP 100a then turns off the power supply of the SP 100b, which is a standby system to the SP 100a, (Step S209), and ends the process of requesting mutual monitoring.

Moreover, in a case where the SP 100a determines that no same type device exists in Step S202 (No in Step S202), the SP 100a operates in a duplicated system with the SP 100b (Step S210), and performs survival monitoring (Step S211). The SP 100a then ends the process of requesting mutual monitoring. Furthermore, in a case where the SP 100a determines that the SP 100a receives a reply not, to permit mutual monitoring in Step S206 (No in Step S206), the SP 100a goes to Step S205.

### A Process when an Abnormality Occurs

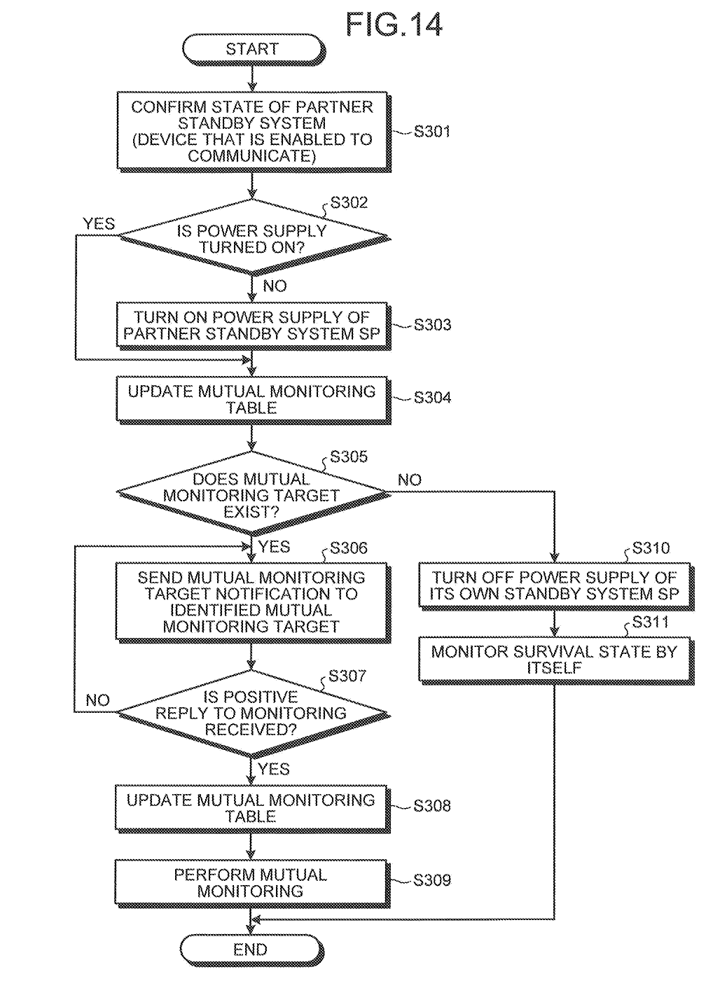

Next, processes performed by the SPs 98a, 99a, 100a, and 101a according to the first embodiment when an abnormality occurs will be described with reference to FIG. 14. FIG. 14 is a flowchart of the process procedures performed by the SPs when an abnormality occurs. It is noted that the process corresponds to the process in Step S104 illustrated in FIG, 12. Moreover, here, the process of the SP 100a will be described when an abnormality occurs as the case is taken as an example where an abnormality occurs in the SP 99a.

As illustrated in FIG. 14, the SP 100a confirms the state of the SP 99b, which is a standby system to the SP 99a that is enabled to communicate (Step S301), and determines whether the power supply is turned on (Step S302). Here, in a case where the SP 100a determines that the power supply of the SP 99b is not turned on (Mo in Step S302), the SP 100a turns on the power supply of the SP 99b, which is a standby system to the SP 99a (Step S303), and goes to Step S304.

On the other hand, in a case where the SP 100a determines that the power supply of the SP 99b is turned on (Yes in Step S302), the SP 100a goes to Step S304. Namely, the SP 100a updates the mutual monitoring table 202 (Step S304).

The SP 100a then determines whether a mutual monitoring target exists (Step S305). Here, in a case where the SP 100a determines that a mutual monitoring target exists (Yes in Step S305), the SP 100a identifies the mutual monitoring target according to a rule, and sends a mutual monitoring target notification to the identified mutual monitoring target (Step S306). After that, the SP 100a determines whether the SP 100a receives a reply to permit mutual monitoring (Step S307).

Here, in a case where the SP 100a determines that the SP 100a receives a reply to permit mutual monitoring (Yes in Step S307), the SP 100a updates the mutual monitoring table 202 (Step S308), and performs mutual monitoring (Step S309). On the other hand, in a case where the SP 100a determines that the SP 100a receives a reply not to permit mutual monitoring in Step S307 (No in Step S307), the SP 100a goes to Step S306.

Moreover, in a case where the SP 100a determines that no mutual monitoring target exists in Step S305 (No in Step S305), the SP 100a performs the following process. Namely, the SP 100a turns on the power supply of the SP 100b, which is a standby system to the SP 100a (Step S310), and monitors the survival state (Step S311). After the SP 100a ends the process in Step S309, or ends the process in Step S311, the SP 100a ends the process when an abnormality occurs.

### The Notification Process when Maintenance is Set

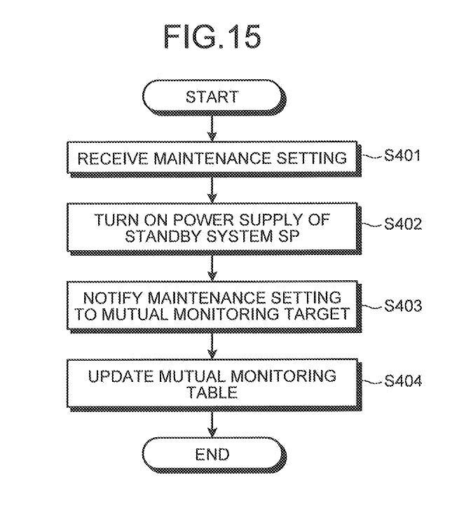

Next, the process procedures of the notification process of the SPs 98a, 99a, 100a, and 101a according to the first embodiment when maintenance is set will be described with reference to FIG. 15. FIG. 15 is a flowchart of the process procedures of processing a notification by the SPs when maintenance is set. It is noted that the process corresponds to the process in Step S106 illustrated in FIG. 12. Moreover, here, the notification process when maintenance is set will be described as the SP 100a is taken as an example, and the similar process is performed at the other SPs.

As illustrated in FIG. 15, the SP 100a receives a maintenance setting (Step S401), and turns on the power supply of the SP 100b, which is a standby system to the SP 100a (Step S402). The SP 100a then notifies the maintenance setting to the mutual monitoring target (Step S403).

Subsequently, the SP 100a receives a reply from the mutual monitoring target, updates the mutual monitoring table 202 (Step S404), and ends the process.

### The Reply Process to a Mutual Monitoring Target Notification

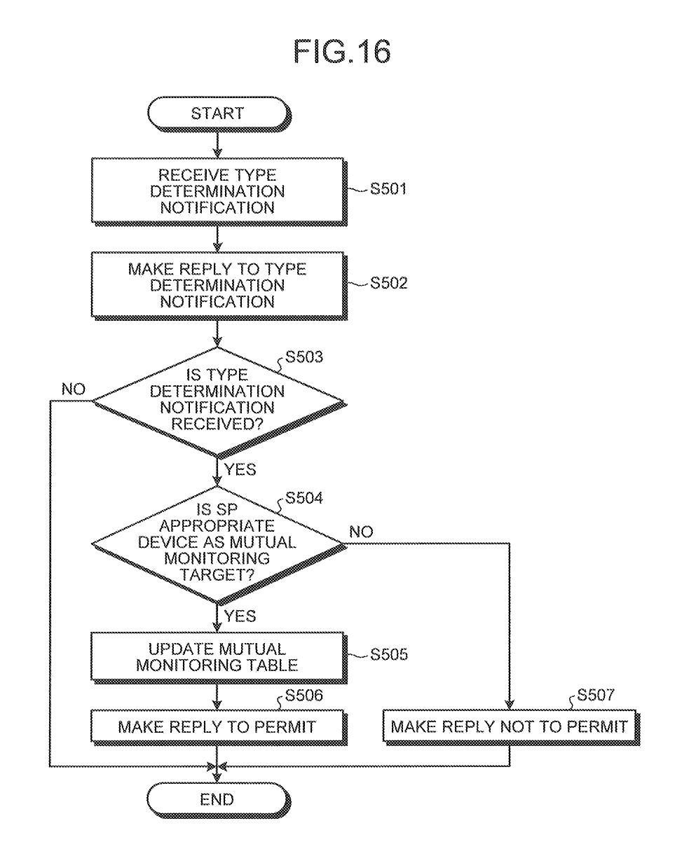

Next, the process procedures of processing a reply to a mutual monitoring target notification performed by the SPs 98a, 99a, 100a, and 101a according to the first embodiment will be described with reference to FIG. 16. FIG. 16 is a flowchart of the process procedures of processing a reply to a mutual monitoring target-notification by the SPs. The SPs 98a, 99a, 100a, and 101a perform the process when receiving a type determination notification. It is noted that here, the reply process to the mutual monitoring target notification will be described as the case is taken as an example where the SP 99a receives a mutual monitoring target notification from the SP 100a, and the similar process is performed at the other SPs.

As illustrated in FIG, 16, the SP 99a receives a type determination notification (Step S501), and makes a reply to the received type determination notification (Step S502). The SP 99a then determines whether the SP 99a receives a mutual monitoring target notification (Step S503). Here, in a case where the SP 99a determines that the SP 99a does not receive any mutual monitoring target notification (No in Step S503), the SP 99a ends the process.

On the other hand, in a case where the SP 99a determines that the SP 99a receives a mutual monitoring target notification (Yes in Step S503), the SP 99a determines whether the SP 100a, which is a partner device, is an appropriate device as a mutual monitoring target (Step S504).

Here, in a case where the SP 99a determines that the partner device is an appropriate device as a mutual monitoring target (Yes in Step S504), the SP 99a updates the mutual, monitoring table 202 (Step S505). Moreover, the SP 99a makes a reply to the partner device that the SP 99a permits the partner device as a mutual monitoring target (Step S506), and ends the process.

On the other hand, in a case where the SP 99a determines that the partner device is not an appropriate device as a mutual monitoring target (No in Step S504), the SP 99a makes a reply to the partner device that the SP 99a does not permit the partner device as a mutual monitoring target (Step S507), and ends the process.

### The Reply Process to a Maintenance Setting Notification

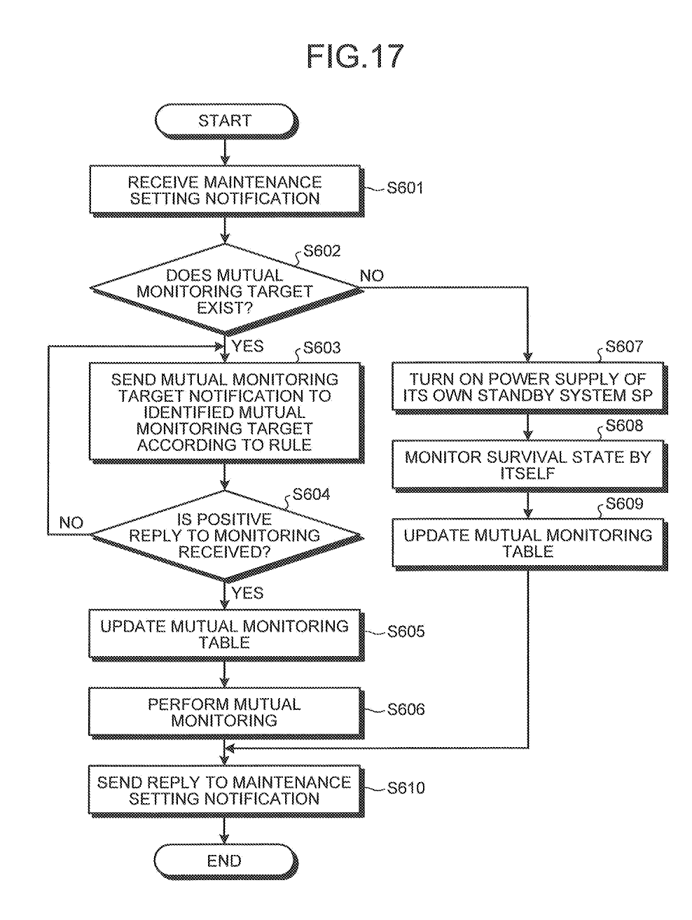

Next, the process procedures of processing a reply to a maintenance setting notification performed by the SPs 98a, 99a, 100a, and 101a according to the first embodiment will be described with reference to FIG. 17. FIG. 17 is a flowchart of the process procedures of processing a reply to a maintenance setting notification. The SPs 98a, 99a, 100a, and 101a perform the process when receiving a maintenance setting notification. It is noted that here, the reply process to the maintenance setting notification will be described as the case is taken as an example where the SP 99a receives a maintenance setting notification from the SP 100a, and the similar process is performed at the other SPs.

As illustrated in FIG. 17, the SP 99a receives a maintenance setting notification (Step S601), and determines whether a mutual monitoring target exists (Step S602). Here, in a case where the SP 99a determines that a mutual monitoring target exists (Yes in Step SS02), the SP 99a identifies the mutual monitoring target according to a rule, and sends a mutual monitoring target notification to the identified mutual monitoring target (Step S603). After that, the SP 99a determines whether the SP 99a receives a reply to permit mutual monitoring (Step S604).

Here, in a case where the SP 99a determines that the SP 99a receives a reply to permit mutual monitoring according to a rule (Yes in Step S604), the SP 99a updates the mutual monitoring table 202 (Step S605), performs mutual monitoring (Step S606), and goes to Step S610. On the other hand, in a case where the SP 99a determines that the SP 99a receives a reply not to permit mutual monitoring in Step S604 (No in Step S604), the SP 99a goes to Step S603.

On the other hand, in a case where the SP 99a determines that no mutual monitoring target exists in Step S602 (No in Step S602), the SP 99a performs the following process, Namely, the SP 99a turns on the power supply of the device SP 99b, which is a standby system to the SP 99a (Step S607), and monitors the survival state (Step S608). The SP 99a then updates the mutual monitoring table 202 (Step S609), and goes to Step S610.

In Step S610, the SP 99a sends a reply to the maintenance setting notification (Step S610), and ends the process.

### The Effect of the First Embodiment

As decried above, the SP according to the first embodiment mutually monitors the survival state with the other operation system SPs, so that the power supply of the standby system SP can be turned off, and it is possible to save electric power.

Moreover, the SP according to the first embodiment controls the power supply of the SP to turn on, which is a standby system to a mutual monitoring target, in a case where an abnormality occurs in the mutual monitoring target. The SP according to the first embodiment then selects a mutual monitoring target from the operation system SPs included in the other information processors. As described above, the SP according to the first embodiment automatically detects a mutual monitoring target. Thus, the user can omit time and effort for changing definitions, for example, even in a case where an abnormality occurs in a mutual monitoring target, or in a case where the configuration of the data center is changed due to adding a new information processor to the HPC 1.

Moreover, the SP according to the first embodiment turns on the power supply of the SP, which is a standby system to this side SP, and operates in a duplicated system in a case where no mutual monitoring target exists. Namely, the SP according to the first embodiment can leave the power supply of the standby system SP off until no mutual monitoring target exists. As a result, a power control method using the SP according to the first embodiment can obtain a high power saving effect. Furthermore, the SP according to the first embodiment puts a limitation on the range of mutual monitoring by the SPs, so that power saving can be implemented without applying an extra load to the network.

In addition, the SP according to the first embodiment notifies the SP in mutual monitoring with this side SP that this side SP is removed from the mutual monitoring target in a case where this side SP is to be in maintenance. The SP in mutual monitoring with the SP to be in maintenance then selects a new mutual monitoring target, and performs mutual monitoring with the selected SP. As a result, the SP in mutual monitoring with the SP to be in maintenance is prevented from wrongly recognizing that the SP to be in maintenance is failed even in a case where the power supply of the SP to be in maintenance or the information processor including the SP to be in maintenance is turned off.

Moreover, the SP according to the first embodiment can freely modify a predetermined rule to select a mutual monitoring target and intervals for mutual monitoring. Thus, the user can apply the power control method disclosed in the present specification depending on the scale of the data center.

Furthermore, the power control method disclosed in the present specification can be implemented as the present hardware configuration is not changed without newly adding a physical component or device. Thus, the user can save the cost, on the initial investment in order to save the electric power of the data center, for example.

### Second Embodiment

The embodiment of the present, invention may be implemented in various different forms other than the forgoing embodiment. Therefore, in a second embodiment, another embodiment included in the embodiment of the present invention will be described.

### The System Configuration and Others

In the processes described in the first embodiment, all or a part of the processes described as automatically performed may be performed manually. Alternatively, ail or a part of the processes described as manually performed may be automatically performed according to a publicly known method. In addition to this, the process procedures, the control procedures, and the specific names described in the paragraphs and drawings can be freely modified unless otherwise specified.

In the first embodiment, a computer system is taken as an example and described where information processors including system controllers formed in a duplicated system are connected to each other via a network. However, the disclosed technique is not limited thereto. For example, the disclosed technique is also applicable to an electronic apparatus including a system controller formed in a duplicated system.

Moreover, in the first embodiment, the SP is taken as an example and decried as an exemplary system controller. However, the disclosed technique is not limited thereto. For example, the disclosed technique is also usable to reduce power consumption in other systems formed in a duplicated system.

Furthermore, in the first embodiment, the case is described where an abnormality occurs in the operation system SP. As described above, in a case where an abnormality occurs in the operation system SP, the SP in which an abnormality occurs is to be replaced by a normal SP. The disclosed technique is also applicable to this case.

For example, in a case where an abnormality occurs in the operation system SP in the SPs formed in a duplicated system, the standby system SP operates. The SP in which an abnormality occurs is then replaced by a normal SP, so that the SP duplicated configuration is restored. The operation system SP then again performs mutual monitoring after establishing the SP duplicated configuration. The mutual monitoring is performed according to the process procedures described in the first embodiment. As a result, in a case where mutual monitoring is established, the operation system SP can control the power supply of the standby system SP to turn off. Namely, the power consumption of the standby system SP can be reduced.

An example is described where the monitoring target, identifying unit 203 receives replies to the type determination notification from the SPs, which are the same type devices, and sorts the replies in order of IP addresses. The disclosed technique is not limited thereto. For example, the monitoring target identifying unit 203 may sort the replies in order of MAC (Media Access Control) addresses.

In addition, information stored on the mutual monitoring table 202 illustrated is merely an example. The mutual monitoring table 202 is allowed to store the information other than as illustrated. For example, the mutual monitoring table 202 may store only “IP addresses” and “mutual monitoring targets” in association with each other.

Moreover, the order of the processes in the steps described in the embodiments may be modified according to various loads and use situations, for example.

Furthermore, the units illustrated in the drawings are allowed to be physically configured other than as illustrated. For example, in the SP 100a, the monitoring target identifying unit 203 and the monitoring request reply unit 204 may be integrated. In addition, all or an optional part of the process functions performed in the devices can be implemented by a CPU and programs analyzed and executed using the CPU or can be implemented as hardware according to wired logic.

According to an aspect of the present invention, it is possible to reduce the power consumption of a system controller, which is a standby system.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system controller included in a first electronic apparatus connected to a different electronic apparatus via a network, the system controller comprising:
a monitoring unit that mutually monitors a survival state with an operation system controller included in a second electronic apparatus; and
a power supply control unit that controls a power supply of a different system controller included in the first electronic apparatus to turn off when the monitoring unit starts monitoring a survival state of the operation system controller included in the second electronic apparatus.

2. The system controller according to claim 1, further comprising, when the monitoring unit detects an abnormality in the operation system controller included in the second electronic apparatus, an abnormality processing unit that, controls a power supply of a standby system controller included in the second electronic apparatus to turn on and identifies a system controller to mutually monitor a survival state from operation system controllers included in a third electronic apparatus connected to the first electronic apparatus via the network,
wherein the monitoring unit mutually monitors a survival state with the system controller of the third electronic apparatus identified at the abnormality processing unit.

3. The system controller according to claim 2, wherein:
when the abnormality processing unit determines that identifying a system controller of the third electronic apparatus to mutually monitor a survival state is not enabled, the power supply control unit controls a power supply of the different system controller included in the first electronic apparatus to turn on; and
the monitoring unit mutually monitors a survival state with the different system controller of which power supply is controlled to turn on.

4. The system controller according to claim 1, further comprising an identifying unit that identifies a system controller to mutually monitor a survival state from operation system controllers included in a different electronic apparatus,
wherein the monitoring unit mutually monitors a survival state with the system controller identified at the identifying unit.

5. The system controller according to claim 4, further comprising a determining unit that receives a request to mutually monitor a survival state from an operation system controller included in a different electronic apparatus and determines whether to permit mutually monitoring a survival state with the system controller that sends the request.

6. The system controller according to claim 5, wherein the identifying unit requests a determining unit of an operation system controller included in a different electronic apparatus to mutually monitor a survival state and identifies the operation system controller included in the different electronic apparatus as a system controller to mutually monitor a survival state when the determining unit permits mutually monitoring a survival state.

7. The system controller according to claim 1, further comprising a maintenance unit that receives a notification that the system controller is set in a maintenance mode and requests the operation system controller included in the second electronic apparatus that mutually monitors a survival state to remove the system controller from a survival state monitoring target,
wherein the power supply control unit controls a power supply of a different system controller included in the first electronic apparatus to turn on when the maintenance unit, sets the system controller in a maintenance mode.

8. A power control method for a system controller included in a first electronic apparatus connected to a different electronic apparatus via a network, the method comprising:
mutually monitoring a survival state with an operation system controller included in a second electronic apparatus; and
first, controlling a power supply of a standby system controller included in the first electronic apparatus to turn off when monitoring a survival state of the operation system controller included in the second electronic apparatus is started.

9. The power control method according to claim 8, further comprising: when an abnormality is detected in an operation system controller included in the second electronic apparatus, second controlling a power supply of a standby system controller included in the second electronic apparatus to turn on; and
first identifying a system controller to mutually monitor a survival state from operation system controllers included in a third electronic apparatus connected to the first electronic apparatus via the network;
wherein the monitoring is mutually monitoring a survival state with the identified system controller of the third electronic apparatus.

10. The power control method according to claim 9, wherein:
when it is determined that the first identifying identifies a system controller of the third electronic apparatus to mutually monitor a survival state is not enabled,
the first controlling controls a power supply of a different system controller included in the first electronic apparatus to turn on; and
the monitoring mutually monitors a survival state with the different system controller of which power supply is controlled to turn on.

11. The power control method according to claim 8, further comprising:
second identifying a system controller to mutually monitor a survival state from operation system controllers included in a different electronic apparatus; and
the monitoring mutually monitors a survival state with the identified system controller.

12. The power control method according to claim 11, further comprising:
first receiving a request to mutually monitor a survival state from an operation system controller included in a different electronic apparatus; and
determining whether to permit mutually monitoring a survival state with the system controller that sends the request.

13. The power control method according to claim 12, further comprising:
first requesting an operation system controller included in a different electronic apparatus to mutually monitor a survival state;
wherein when mutually monitoring a survival state is permitted, the second identifying identifies the operation system controller included in the different electronic, apparatus as a system controller to mutually monitor a survival state.

14. The power control method according to claim 8, further comprising:
second receiving a notification that the system controller is set in a maintenance mode;
second requesting the operation system controller included in the second electronic apparatus that mutually monitors a survival state to remove the system controller from a survival state monitoring target;
wherein the first controlling controls a power supply of a different system controller included in the first electronic apparatus to turn on when the system controller is set in a maintenance mode.

15. An electronic system comprising:
a plurality of electronic apparatuses including a system controller formed in a redundant system using an operation system and a standby system, the plurality of electronic apparatuses being connected via a network, wherein;
the system controller included in a first electronic apparatus comprises:
a monitoring unit that mutually monitors a survival state with an operation system controller included in a second electronic apparatus when the system controller is set to an operation system; and
a power supply control unit that controls a power supply of a system controller included in the first, electronic apparatus to turn off, which is a standby system to the system controller, when the monitoring unit starts monitoring a survival state of the operation system controller included in the second electronic apparatus.

16. The electronic system according to claim 15, further comprising, when the monitoring unit detects an abnormality in the operation system controller included in the second electronic apparatus, an abnormality processing unit that controls a power supply of a standby system controller included in the second electronic apparatus to turn on and identifies a system controller to mutually monitor a survival state from operation system controllers included in a third electronic apparatus connected to the first electronic apparatus via the network,
wherein the monitoring unit mutually monitors a survival state with the system controller of the third electronic apparatus identified at the abnormality processing unit.
